(19) United States
(12) Patent Application Publication
(10) Pub. No.: US 2010/0310151 A1
(43) Pub. Date: Dec. 9, 2010

(54) ELECTRONIC DEVICE HANDLING APPARATUS AND ELECTRONIC DEVICE POSITION DETECTION METHOD

(75) Inventors: Aritomo Kikuchi, Tokyo (JP); Tatsumi Koike, Tokyo (JP)

Correspondence Address: POSZ LAW GROUP, PLC, 12040 SOUTH LAKES DRIVE, SUITE 101, RESTON, VA, 20191, US

(73) Assignee: ADVANTEST CORPORATION, Tokyo (JP)

(21) Appl. No.: 12/864,742

(22) PCT Filed: Dec. 22, 2008
(86) PCT No.: PCT/JP2008/073290

§ 371 Date: Aug. 18, 2010

(30) Foreign Application Priority Data
Jan. 29, 2008 (JP) 2008-017308

(51) Int. Cl. G06K 9/48; G06K 9/00

(52) U.S. Cl. 382/149; 382/199

(57) ABSTRACT

An electronic device handling apparatus, wherein an image of terminals of an electronic device to be tested having the terminals at its end edge portions held by a conveyor device is taken, edges of terminals arranged in the X-axis direction are extracted from data of an taken image and binarization processing is performed on the data, while edges of terminals arranged in the Y-axis direction are extracted from data of the taken image and binarization processing is performed on the data, so that positions of edges of respective terminals are located from the obtained two binary images. Then, a positional deviation amount of the electronic device is calculated by comparing with reference positional information of edges of terminals of a reference electronic device and, based thereon, a posture of the electronic device to be tested is corrected.

### TECHNICAL FIELD

The present invention relates to an electronic device handling apparatus, which can detect positions of electronic devices to be tested each having terminals at its end edge portions, an electronic device position detection method, a detection method of positional deviation, a posture correction method, a defective terminal detection method and an electronic device size checking method.

### BACKGROUND ART

In a production procedure of an electronic device, such as an IC device, an electronic device testing apparatus is used for testing performance and functions of the finally produced electronic device.

An electronic device testing apparatus as an example of the related art is provided with a test section for conducting a test on electronic devices, a loader section for sending pre-test IC devices to the test section and an unloader section for taking out post-test IC devices from the test section and classifying them. The loader section is provided with a buffer stage capable of moving back and forth between the loader section and the test section, and a loader section conveyor device, wherein suction portions for picking up and holding IC devices are provided, capable of moving in a range from a customer tray to a heat plate and from the heat plate to the buffer stage. Also, the test section is provided with contact arms capable of picking up and holding IC devices and pressing them against sockets of a test head and a test section conveyor device capable of moving in a range of the test section.

In the loader section conveyor device, IC devices carried on the customer tray are picked up and held by the suction portions and loaded on the heat plate and, then, the IC devices heated to be a predetermined temperature on the heat plate are again picked up and held by the suction portions and loaded on the buffer stage. Then, the buffer stage loaded with the IC devices moves from the loader section to the test section side. Next, the test section conveyor device uses the contact arm to pick up and hold the IC devices on the buffer stage and presses them against sockets of the test head, so that external terminals (device terminals) of the IC devices are brought to contact with contact terminals (socket terminals) of the sockets.

In that state, by applying to the IC devices test signals supplied to the test head from the tester body through a cable and sending response signals read from the IC devices to the tester body through the test head and cable, electric characteristics of the IC devices are measured.

Here, when the contact arm of the test section conveyor device presses the IC devices against the sockets as explained above, if holding positions of the IC devices on the contact arm are deviated, contact between device terminals and socket terminals is not secured and the test cannot be conducted accurately. Accordingly, positions of IC devices on the contact arm have to be regulated accurately.

Particularly, in recent years, IC devices to be used in mobile phones and other mobile communication devices have been developed to have a smaller area and a thinner body, while the number of device terminals has rapidly increased as the integrated circuit has become furthermore highly integrated and come to provide more functions. Therefore, finer device terminals and narrower pitches at arrangement intervals have been pursued. When the pitches of the device terminals become narrower and finer, attaining of accurate contact between the device terminals and the socket terminals becomes harder.

To solve the problem, electronic device testing apparatuses for measuring a position of an IC device by using an image processing technique and aligning it with sockets of the test head have been developed (for example, the patent article 1). In such an electronic device testing apparatus, an image of an IC device to be tested in the middle of being conveyed by a conveyor is taken by an optical image pickup apparatus, such as a CCD (charge-coupled device) camera, and an amount of positional deviation of the IC device is calculated based on the obtained image. The conveyor device corrects a posture of the IC device to be tested based on the calculated positional deviation and conveys the IC device to the sockets. Calculation of a positional deviation amount of the IC device is performed, for example, by detecting device terminals in the image by using an image processing technique and comparing the center coordinates (coordinates of a gravity center) of the respective device terminals with that of respective device terminals of a reference IC device.

[Patent Article 1]

The International Publication Gazette No. 03/075025

### DISCLOSURE OF THE INVENTION

However, when an IC device to be tested has device terminals (pads 2a) at its end edge portions, such as a QFN (Quad Flat Non-leaded package) shown in FIG. 5, if the background of the IC device 2 shines, as shown in FIG. 11, only an image wherein the pads 2a look connected with the bright part on the background is obtained. A binary image obtained by performing binarization processing on the image is shown in FIG. 12, however, it has the same problem. A gravity center of the pads 2a cannot be calculated from such an image, wherein the pads 2a are connected as explained above, and positions of the pads 2a cannot be located. In this case, a positional deviation amount of the IC device cannot be calculated and an accurate alignment of the IC device with respect to the sockets becomes difficult.

To solve such a problem as above, conventionally, a contact chuck of the contact arm was made by a black plastic resin or black alumite was formed on an aluminum contact chuck, so that the background of the IC device as an image-taking subject does not shine.

However, when making the contact chuck with a plastic resin, heat resistance of the contact chuck becomes poor which results in a problem that a high temperature measurement of an IC device becomes impossible. Also, when forming alumite on the contact chuck, there is a problem that the alumite wears out due to frequent use and the base aluminum exposes, so that the background of an IC device results in shining.

The present invention was made in consideration of the above circumstances and has as an object thereof to provide an electronic device handling apparatus capable of accurately locating positions of terminals even in the case of an electronic device having terminals at its end edge portions, an electronic device position detection method, a positional deviation detection method, a posture correction method, a defective terminal detection method and an electronic device size checking method.

To attain the above object, firstly, according to the present invention, there is provided an electronic device handling apparatus for conducting a test of electric characteristics of an electronic device having terminals at its end edge portions by conveying the electronic device to a contact portion and bringing it electrically contact with the contact portion, comprising an image pickup apparatus for taking an image of terminals of a predetermined electronic device, and an edge detection means for extracting edges of terminals of the electronic device from data of an image taken by the image pickup apparatus and locating positions of the edges (Invention 1).

According to the above invention (Invention 1), in the case of testing an electronic device having terminals at its end edge portions, even if the background of the electronic device shines at the time of taking an image thereof and an image wherein respective terminals are connected with the bright portion of the background is obtained, edges of the terminals of the electronic device can be detected, consequently, positions of the terminals can be located accurately.

In the above invention (Invention 1), preferably, the edge detection means extracts edges of terminals being in the direction crossing with an arrangement direction of terminals of the electronic device (Invention 2).

In the above inventions (Inventions 1 and 2), when the electronic device has terminals at its end edge portions in the X-axis direction and end edge portions in the Y-axis direction, it is preferable that the edge detection means extracts edges of terminals arranged in the X-axis direction of the electronic device and extracts edges of terminals arranged in the Y-axis direction of the electronic device (Invention 3).

In the above (Inventions 1 to 3), preferably, the edge detection means performs scanning in a predetermined direction on terminals of the electronic device and extracts edges where light changes to dark and edges where dark changes to light (Invention 4).

In the above (Invention 4), preferably, the edge detection means locates positions of edges of the terminals after performing binarization processing on the extracted edges (Invention 5).

In the above (Invention 5), binarization may be performed by taking out edges where light changes to dark and edges where dark changes to light at a time (Invention 6) or may be performed by taking out edges where light changes to dark and edges where dark changes to light separately (Invention 7) in the binarization processing.

In the above (Inventions 4 to 7), when the electronic device has terminals on its end edge portions in the X-axis direction or its end edge portions in the Y-axis direction, it is preferable that the scanning is performed along an arrangement direction of terminals of the electronic device (Invention 8).

In the above (Inventions 4 to 7), when the electronic device has terminals on its end edge portions in the X-axis direction and its end edge portions in the Y-axis direction, it is preferable that the scanning is performed in the X-axis direction and the Y-axis direction (Invention 9).

In the above (Inventions 1 to 9), preferably, the electronic device handling apparatus comprises a conveyor device capable of holding an IC device and pressing it against the contact portion, and the image pickup apparatus takes an image of terminals of a pre-test electronic device held by the conveyor device (Invention 10).

In the above (Inventions 1 to 10), it is preferable to furthermore comprise a memory device for storing reference positional information of edges of terminals of a reference electronic device and a positional deviation detection means for reading the reference positional information of the edges from the memory device, comparing the read-out reference positional information of edges with information of positions of the edges located by the edge detection means and calculating a positional deviation amount of the predetermined electronic device (Invention 11).

In the above (Invention 11), preferably, the electronic device handling apparatus comprises a conveyor device capable of holding an IC device and pressing it against the contact portion: wherein the conveyor device comprises a posture correction device for correcting a posture of an electronic device held by the conveyor device, the image pickup apparatus takes an image of terminals of pre-test electronic device held by the conveyor device, and the conveyor device corrects a posture of an electronic device held by the conveyor device based on a positional deviation amount of the electronic device detected by the positional deviation detection means (Invention 12).

In the above (Inventions 1 to 12), it may furthermore comprise a memory device for storing reference positional information of edges of terminals of a reference electronic devices, and a defective terminal detection means for detecting a defective terminal of the predetermined electronic device by reading the reference positional information of edges from the memory device and comparing the read-out reference positional information of edges with information of positions of the edges located by the edge detection means (Invention 13).

Secondly, according to the present invention, there is provided an electronic device handling apparatus for conducting a test of electric characteristics of an electronic device having terminals at its end edge portions by conveying the electronic device to a contact portion and bringing it electrically contact with the contact portion, comprising an image pickup apparatus for taking an image of terminals of a predetermined electronic devices, an edge pitch detection means for detecting edge pitches of the terminals by extracting edges of terminals of the electronic device from data of image taken by the image pickup apparatus, a memory device for storing reference pitch information of edges of terminals of a reference electronic device, and a size checking means for checking a size of the predetermined electronic device by reading reference pitch information of edges of terminals of a reference electronic device and comparing the read-out reference pitch information of edges with information of the edge pitches detected by the edge pitch detection means (Invention 14). Note that, in the present specification, “an electronic device size” includes a (external) size of the electronic device itself and a size of terminals of the electronic device.

According to the above invention (Invention 14), by extracting edges and locating positions of the edges, the edge pitches can be detected accurately even in the case of an electronic device having terminals at its end edge portions. A defect of terminals of the electronic device can be detected when the edge pitches are different from the reference. Also, because the external size of the electronic device normally corresponds to edge pitches of terminals of the electronic device by one to one, when the edge pitches are different from the reference, it is possible to detect that the external size of the electronic device is wrong or that a kind of the electronic device to be tested is wrong.

Thirdly, according to the present invention, there is provided a position detection method for detecting a position of an electronic device having terminals at its end edge portion in an electronic device handling apparatus, comprising a first step of taking an image of terminals of an electronic device, and a second step of extracting edges of terminals of the electronic device from data of an image taken in the first step and locating a position of the edges (Invention 15).

In the above (Invention 15), preferably, the second step includes extracting of edges of terminals being in the direction crossing with an arrangement direction of terminals of the electronic device (Invention 16).

In the above (Inventions 15 and 16), when the electronic device has terminals at its end edge portions in the X-axis direction and end edge portions in the Y-axis direction, it is preferable that the second step comprises a step of extracting edges of terminals arranged in the X-axis direction of the electronic device and a step of extracting edges of terminals arranged in the Y-axis direction of the electronic device (Invention 17).

In the above (Inventions 15 to 17), preferably, the second step includes performing of scanning in a predetermined direction on terminals of the electronic device and extracting of edges where light changes to dark and edges where dark changes to light (Invention 18)

In the above (Invention 18), preferably, positions of edges of the terminals are located after performing binarization processing on the extracted edges in the second step (Invention 19).

In the above (Invention 19), binarization may be performed by taking out edges where light changes to dark and edges where dark changes to light at a time (Invention 20) or may be performed by taking out edges where light changes to dark and edges where dark changes to light separately (Invention 21) in the binarization processing.

In the above (Inventions 18 to 21), when the electronic device has terminals at its end edge portions in the X-axis direction or its end edge portions in the Y-axis direction, it is preferable that the scanning is performed along an arrangement direction of terminals of the electronic device (Invention 22).

In the above (Inventions 18 to 21), when the electronic device has terminals at its end edge portions in the X-axis direction and its end edge portions in the Y-axis direction, it is preferable that the scanning is performed in the X-axis direction and the Y-axis direction (Invention 23).

Fourthly, according to the present invention, there is provided a positional deviation detection method for detecting positional deviation of an electronic device having terminals at its end edge portions in an electronic device handling apparatus, comprising a first step of storing reference positional information of edges of terminals of a reference electronic device, a second step of taking an image of terminals of a predetermined electronic device, a third step of extracting edges of terminals of the electronic device from data of an image taken in the second step and locating positions of the edges, and a fourth step of reading reference positional information of the edges from the memory device, comparing the read-out reference positional information of edges with information of positions of the edges located in the third step and calculating a positional deviation amount of the predetermined electronic device (Invention 24).

Fifthly, according to the present invention, there is provided a posture correction method for correcting a posture of an electronic device having terminals at its end edge portions held by a conveyor device in an electronic device handling apparatus, comprising a first step of storing reference positional information of edges of terminals of a reference electronic device, a second step of taking an image of terminals of an electronic device held by the conveyor device, a third step of extracting edges of terminals of the electronic device from data of an image taken in the second step and locating positions of the edges, a fourth step of reading reference positional information of the edges from the memory device, comparing the read-out reference positional information of edges with information of positions of the edges located in the third step and calculating a positional deviation amount of an electronic device held by the conveyor device, and a fifth step of correcting a posture of an electronic device held by the conveyor device based on a positional deviation amount of the electronic device detected in the fourth step (Invention 25).

Sixthly, according to the present invention, there is provided a defective terminal detection method for detecting a defective terminal of an electronic device having terminals at its end edge portions in an electronic device handling apparatus, comprising a first step of storing reference positional information of edges of terminals of a reference electronic device, a second step of taking an image of terminals of a predetermined electronic device, a third step of extracting edges of terminals of the electronic device from data of an image taken in the second step and locating positions of the edges, and a fourth step of reading reference positional information of the edges from the memory device and comparing the read-out reference positional information of edges with information of positions of the edges located in the third step so as to detect a defective terminal of the predetermined electronic device (Invention 26).

Seventhly, according to the present invention, there is provided a size checking method for checking a size of an electronic device having terminals at its end edge portions in an electronic device handling apparatus, comprising a first step of storing reference pitch information of edges of terminals of a reference electronic device, a second step of taking an image of terminals of a predetermined electronic device, a third step of extracting edges of terminals of the electronic device from data of an image taken in the second step and detecting edge pitches of the terminals, and a fourth step of reading reference pitch information of the edges from the memory device and comparing the read-out reference pitch information of edges with information of the edge pitches detected in the third step so as to check a size of the predetermined electronic device (Invention 27).

According to the present invention, positions of terminals can be located accurately even in the case of an electronic device having the terminals at its end edge portions.

### BRIEF DESCRIPTION OF DRAWINGS

FIG. 1 is a plan view of a handler according to an embodiment of the present invention.

FIG. 2 is a sectional view from the side of a part of the handler according to the same embodiment (a sectional view along I-I in FIG. 1).

FIG. 3 is a view from the side of a contact arm and an image pickup apparatus used in the handler.

FIG. 4 is a view from the side of the contact arm and a contact portion used in the handler.

FIG. 5 is a bottom surface view of an IC device (QFN).

FIG. 6 is a view showing edges in the X-axis direction of an IC device.

FIG. 7 is a view showing an image wherein edges in the X-axis direction of an IC device are extracted.

FIG. 8 is a view showing edges in the Y-axis direction of an IC device.

FIG. 9 is a view showing an image wherein edges in the Y-axis direction of an IC device are extracted.

FIG. 10 is a flowchart showing an operation of the handler.

FIG. 11 is a taken image of an IC device.

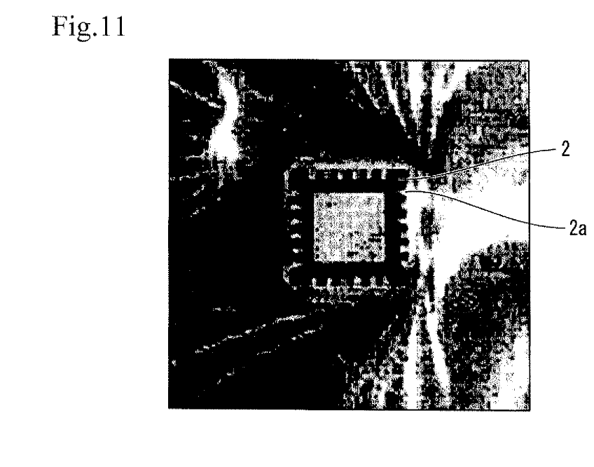

FIG. 12 is a conventional binary image of a taken image of an IC device.

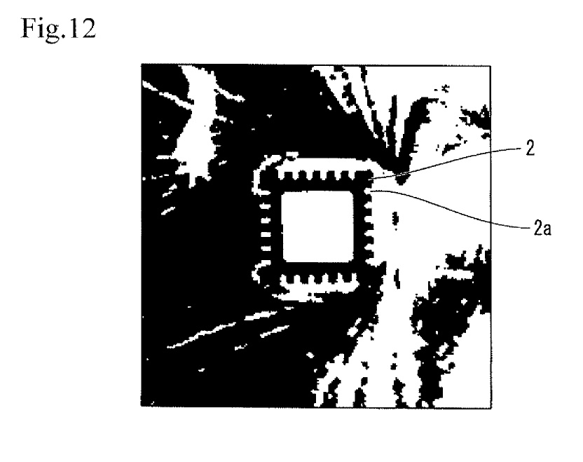

### BEST MODES FOR CARRYING OUT THE INVENTION

Below, an embodiment of the present invention will be explained based on the drawings.

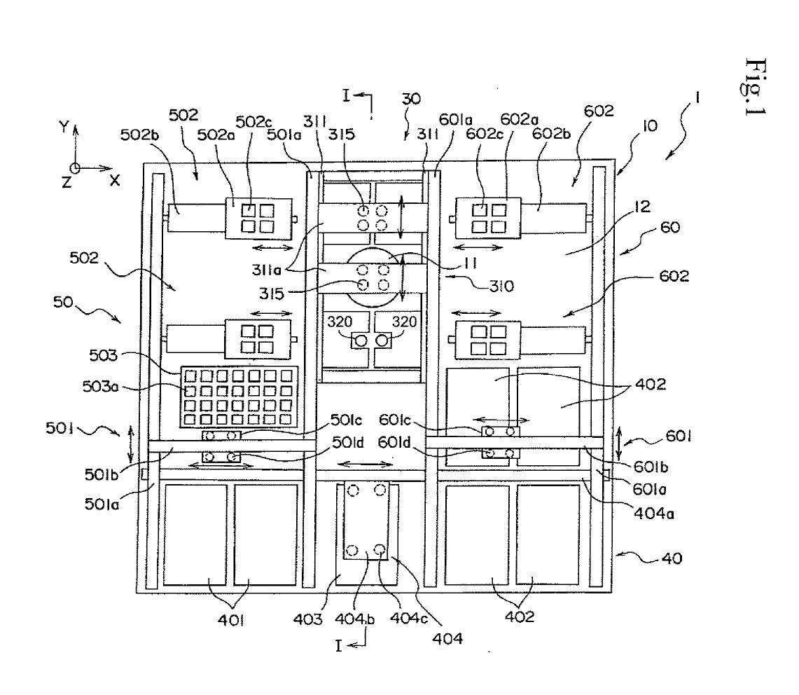

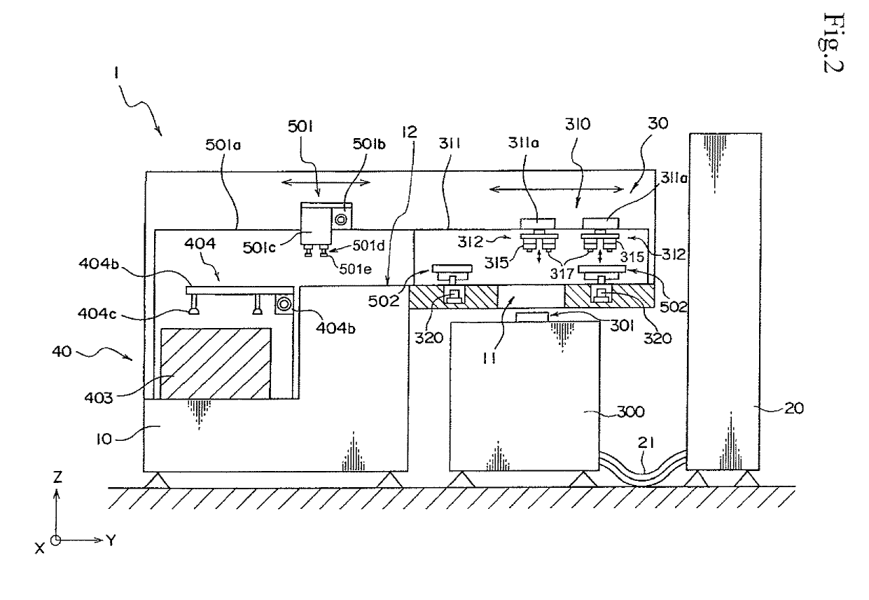

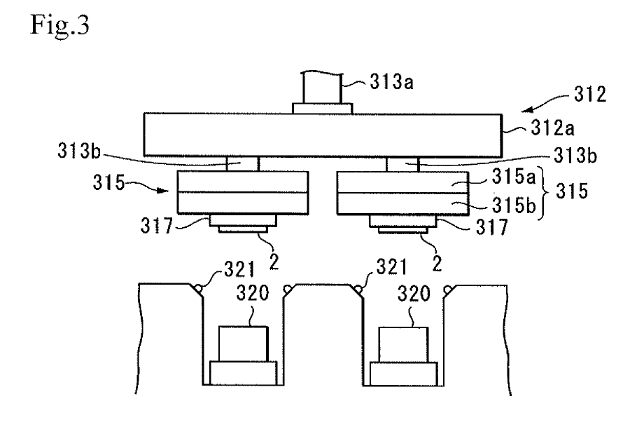

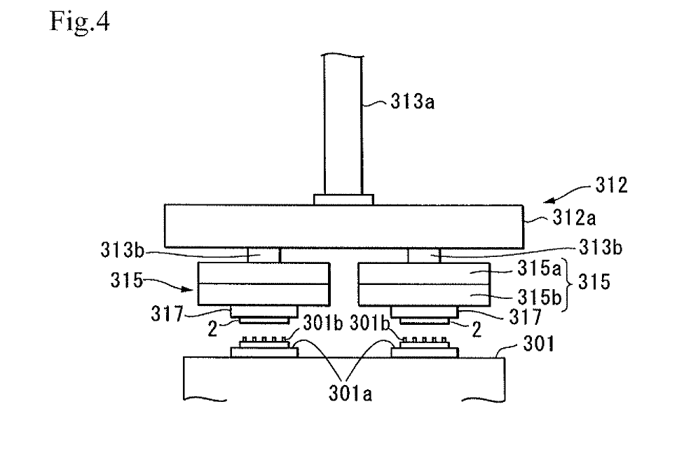

FIG. 1 is a plan view of a handler according to an embodiment of the present invention; FIG. 2 is a sectional view from the side of a part of the handler according to the same embodiment (a sectional view along I-I in FIG. 1); FIG. 3 is a view from the side of a contact arm and an image pickup apparatus used in the handler; and FIG. 4 is a view from the side of the contact arm and a contact portion used in the handle.

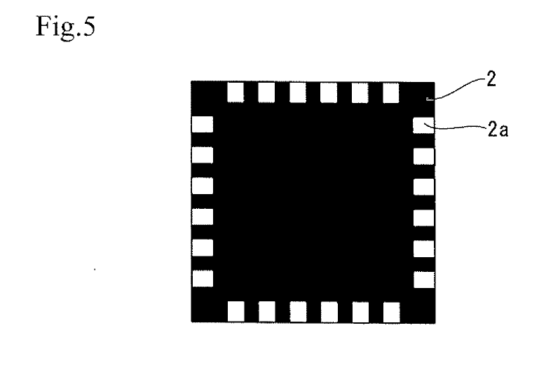

Note that IC devices to be tested in the present embodiment are electronic devices having terminals at their end edge portions, and a QFN shown in FIG. 5 is taken as an example for an explanation in the present embodiment, however, the present invention is not limited to that. For example, the IC devices to be tested may be QFP (Quad Flat Packages), PLCC (Plastic Leaded Chip Carriers) and SOP (Small Outline Packages), etc.

As shown in FIG. 5, an end edge portion of each of four sides on the bottom surface of an IC devices 2 (QFN) is provided with pads 2a as terminals. Normally, a body portion of an IC device 2 is black and the pads 2a are metal color, such as gold. The pads 2a become white in image processing.

As shown in FIG. 1 and FIG. 2, an electronic device testing apparatus 1 in the present embodiment comprises a handler 10, a test head 300 and a tester 20, wherein the test head 300 and the tester 20 are connected via a cable 21. Pre-test IC devices on a supply tray stored in a supply tray stocker 401 of the handler 10 are conveyed and pressed against the contact portion 301 of the test head 300, a test of the IC devices is conducted via the test head 300 and the cable 21, then, the post-test IC devices are loaded on the classification trays stored at the classification tray stockers 402 in accordance with the test results.

The handler 10 mainly comprises a test section 30, an IC device magazine 40, a loader section 50 and an unloader section 60. Below, each component will be explained.

IC Device Magazine 40

The IC device magazine 40 is a means for storing pre-test and post-test IC devices and mainly comprises a supply tray stocker 401, a classification tray stocker 402, an empty tray stocker 403 and a tray conveyor device 404.

In the supply tray stocker 401, a plurality of stacked supply trays each loaded with a plurality of pre-test IC devices are placed and, in the present embodiment, two supply tray stockers 901 are provided as shown in FIG. 1.

In the classification tray stocker 402, a plurality of stacked classification trays loaded with a plurality of post-test IC devices are placed and, in the present embodiment, four classification tray stockers 902 are provided as shown in FIG. 1. By providing the four classification tray stockers, it is configured that IC devices can be classified to four classes at maximum and stored in accordance with the test results.

The empty tray stocker 403 stores empty trays after supplying all pre-test IC devices 2 carried in the supply tray stocker 401 to the test section 30. Note that the number of the respective stockers 401 to 403 may be suitably set in accordance with need.

The tray conveyor device 904 is a conveyor means movable in the X-axis and Z-axis directions in FIG. 1 and mainly comprises an X-axis direction rail 404a, a movable head portion 404b and four suction pads 404c. An operation range thereof includes a range of the supply tray stockers 401, a part of the classification tray stockers 402 and the empty tray stockers 403.

In the tray conveyor device 404, the X-axis direction rail 404a fixed to a base 12 of the handler 10 supports the movable head portion 404b by allowing it to be movable in the X-axis direction. The movable head portion 404b is provided with a not shown Z-axis direction actuator and four suction pads 404c at its tip portion.

The tray conveyor device 404 picks up and holds by the suction pads 404c an empty tray emptied at the supply tray stocker 401 and transfers them to the empty tray stocker 401 by elevating them by the Z-axis actuator and sliding the movable head portion 404b on the X-axis direction rail 404a. In the same way, when a classification tray becomes full with loaded post-test IC devices in the classification tray stocker 402, an empty tray is picked up from the empty tray stocker 403, held by suction, and elevated by the 1-axis direction actuator and transferred by sliding the movable head portion 404b on the X-axis direction rail 404a to the classification tray stocker 402.

Loader Section 50

The loader section 50 is a means for supplying pre-test IC devices from the supply tray stocker 401 of the IC device magazine 40 to the test section 30 and mainly comprises a loader section conveyor device 501, two loader buffer portions 502 (two in the X-axis negative direction in FIG. 1) and a heat plate 503.

Pre-test IC devices are moved from the supply tray stocker 401 to the heat plate 503 by the loader section conveyor device 501 and, after heated to be a predetermined temperature by the heat plate 503, moved again to the loader buffer portion 502 by the loader section conveyor device 501 and introduced to the test section 30 by the loader buffer section 502.

The loader section conveyor device 501 is a means for moving IC devices on a supply tray in the supply tray stocker 401 of the IC device magazine 40 to on the heat plate 503 and moving IC devices on the heat plate 503 to on the loader buffer portion 502 and composed mainly of a Y-axis direction rail 501a, an X-axis direction rail 501b, a movable head portion 501c and a suction portions 501d. The loader section conveyor device 501 operates in a range including the supply tray stocker 401, heat plate 503 and two loader buffer sections 502.

As shown in FIG. 1, the two Y-axis direction rails 501a of the loader section conveyor device 501 are fixed to the base 12 of the handler 10, and between them is the X-axis direction rail 502b supported to be able to slide in the Y-axis direction. The X-axis direction rail 502b supports the movable head portion 501c having a Z-axis direction actuator (not shown) by allowing it to slide in the X-axis direction.

The movable head portion 501c is provided with four suction portions 501d each having a suction pad 501e at its lower end portion and capable of moving the four suction portions 501d up and down in the Z-axis direction independently from one another by driving the Z-axis direction actuator.

Each of the suction portions 501d is connected to a negative-pressure source (not shown), capable of picking up and holding an IC device by generating a negative pressure by drawing air from the suction pad 501e and releasing the IC device by stopping drawing air from the suction pad 501e.

The heat plate 503 is a heat source for applying a predetermined thermal stress to IC devices, for example, a metal heat transfer plate having a heat source (not shown) at its lower part. On an upper surface of the heat plate 503, a plurality of recessed portions 503a for IC devices to be dropped in are formed. Note that a cooling source may be provided instead of the heat source.

The loader buffer portion 502 is a means for moving IC devices back and forth between an operation range of the loader section conveyor device 501 and an operation range of the test section conveyor device 310 and mainly comprises a buffer stage 502a and an X-axis direction actuator 502b.

The buffer stage 502a is supported at one end portion of the X-axis direction actuator 502b fixed to the base 12 of the handler 10. On the upper surface of the buffer stage 502a, four recessed portions 502c each having a rectangular shape when seeing two dimensionally are formed for IC devices to be dropped in. Each of the recessed portions 502c is provided with a suction means (not shown) for holding by suction an IC device placed in the recessed portion 502c.

Test Section 30

The test section 30 is a means for conducting a test by bringing pads 2a of IC devices to be tested 2 contact with contact pins 301b of sockets 301a of the contact portion 301 after correcting postures of the IC devices 2. It is configured to mainly comprise

Four pre-test IC devices loaded on the loader buffer section 502 are conveyed to above image pickup apparatuses 320 by the test section conveyor device 310, where postures thereof are corrected, then, moved to the contact portion 301 of the test head 300, subjected to a test by the number of four at a time, then, moved again by the test section conveyor device 310 to an unloader buffer portion 602 and taken out by the unloader buffer portion 602 to the unloader section 60.

Two image pickup apparatuses 320 are provided on each of both sides of the contact portion 301 of the test head 300 in the Y-axis direction as shown in FIG. 1. As the image pickup apparatus 320, for example, a COD camera may be used, but it is not limited to that and may be any as far as it is a device capable of taking a picture of an object by arranging a large number of image pickup devices, such as a MOS (metal oxide semiconductor) sensor array.

As shown in FIG. 3, each of the image pickup apparatuses 320 is installed in a recessed portion formed on the base 12 of the handler 10, and a lighting device 321 for lighting brightly an IC device 2 positioned above the image pickup apparatus 320 is provided at an upper end portion of the recessed portion. Note that the respective image pickup apparatuses 320 are connected to a not shown image processing apparatus.

As shown in FIG. 4, the contact portion 301 of the test head 300 is provided with four sockets 301a in the present embodiment, and the four sockets 301a are arranged to practically match with an arrangement of contact arms 315 of the movable head portion 312 of the test section conveyor device 310. Furthermore, each socket 301a is provided with a plurality of contact pins 301b in an arrangement of being substantially matching with an arrangement of soldering balls 2a of an IC device 2.

As shown in FIG. 2, in the test section 30, an opening portion 11 is formed on the base 12 of the handler 10 and the contact portion 301 of the test head 300 comes out through the opening portion 11 so as to be pressed by an IC device.

The test section conveyor device 310 is a means for moving IC devices 2 among the loader buffer portions 502, the unloader buffer portion 602 and the test head 300.

In the test section conveyor device 310, two X-axis direction supporting members 311a being able to slide in the Y-axis direction are supported by two Y-axis direction rails 311 fixed to the base 12 of the handler 10. The movable head portion 312 is supported at the center part of each of the X-axis direction supporting members 311a, and an operation range of the movable head portion 312 includes the loader buffer portions 502, the unloader buffer portion 602 and the test head 300. Note that the movable head portions 312 supported respectively by the two X-axis direction supporting members 311a operating at the same time on a set of Y-axis direction rails 311 are controlled so as not to interfere with each other.

As shown in FIG. 3 and FIG. 4, each of the movable head portions 312 comprises a first Z-axis direction actuator 313a, whose upper end is fixed to the X-axis direction supporting member 311a, a supporting base body 312a fixed to a lower end of the first Z-axis direction actuator 313a, four of second Z-axis direction actuators 313b, whose upper ends are fixed to the supporting base body 312a, and four contact arms 315 fixed to lower ends of the second Z-axis direction actuators 313b. The four contact arms 315 are provided to be corresponding to an arrangement of the socket 301a, and the lower end portions of the contact arms 315 are provided with suction portions 317.

Each of the suction portions 317 is connected to a negative-pressure source (not shown) and capable of picking up and holding an IC device 2 by generating a negative pressure by drawing air from the suction portion 317 and releasing the IC device 2 by stopping drawing air from the suction portion 317.

According to the movable head portion 312 explained above, four IC devices 2 held by the contact arm 315 can be moved in the Y-axis direction and Z-axis direction and pressed against the contact portion 301 of the test head 300.

The contact arm 315 in the present embodiment has a posture correcting mechanism capable of correcting postures of IC devices 2 picked up and held by the suction portions 317, which is composed of a base portion 315a positioned on the upper side and a movable portion 315b positioned on the lower side being movable in the X-axis direction, Y-axis direction and the direction of rotating when seeing two dimensionally (0 direction).

The contact arm 315 is capable of bringing the pads 2a of the IC devices 2 surely contact with the contact pins 301b of the sockets 301a by pressing the IC devices 2 against the sockets 301a after correcting postures of IC devices 2 held by the contact arm 315 based on a posture correction amount of the IC devices 2 calculated by the image processing apparatus from image data obtained by the image pickup apparatus 320. Details of operations from image pickup to posture correction will be explained later on.

Unloader Section 60

The unloader section 60 is a means for taking out post-test IC devices 2 from the test section 30 to the IC device magazine 40 and mainly comprises an unloader section conveyor device 601 and two unloader buffer portions 602 (two in the X-axis positive direction in FIG. 1).

Post-test IC devices 2 loaded on the unloader buffer portions 602 are taken out from the test section 30 to the unloader section 60 and loaded on the classification trays in the classification tray stockers 402 from the unloader buffer portions 602 by the unloader section conveyor devices 601.

The unloader buffer portion 602 is a means for moving IC devices 2 back and forth between an operation range of the test section conveyor device 310 and an operation range of the unloader section conveyor device 601 and mainly comprises a buffer stage 602a and an X-axis direction actuator 602b.

The buffer stage 602a is supported at one end portion of the X-axis direction actuator 602b fixed on the base 12 of the handler 10, and four recessed portions 602c for IC devices 2 to be dropped in are formed on an upper surface of the buffer stage 602a.

The unloader section conveyor device 601 is a means for moving and loading IC devices 2 on the unloader buffer portion 602 to the classification trays at the classification tray stockers 402 and mainly comprises a Y-axis direction rail 601a, an X-axis direction rail 601b, a movable head portion 601c and a suction portion 601d. An operation range of the unloader section conveyor device 601 includes two unloader buffers 602 and classification tray stockers 402.

As shown in FIG. 1, two Y-axis direction rails 601a of the unloader section conveyor device 601 are fixed to the base 12 of the handler 10, and the X-axis direction rail 602b is supported being able to slide in the Y-axis direction between them. The X-axis direction rail 602b supports a movable head portion 601c provided with a Z-axis direction actuator (not shown) by allowing it to slide in the X-axis direction.

The movable head portion 601c is provided with four suction portions 601d, each having a suction pad at its lower end portion, and capable of moving the four suction portions 601d up and down in the Z-axis direction independently from one another by driving the Z-axis direction actuator.

The handler 10 according to the present embodiment is furthermore provided with a memory device for storing model data of a variety of IC devices and a display device for displaying an image of IC devices 2 (both not illustrated). Note that the model data of IC devices includes reference positional information of edges of each pad of reference IC devices.

Next, an operation of the above-explained handler 10 will be explained.

First, the loader section conveyor device 501 uses the suction pads 501e of the four suction portions 501d to pick up and hold four IC devices 2 on the supply tray positioning at the uppermost level of the supply tray stocker 401 of the IC device magazine 40.

The loader section conveyor device 501 elevates the four IC devices by the Z-axis direction actuator of the movable head portion 501c while holding the four IC devices 2, slides the X-axis direction rail 501b on the Y-axis direction rail 501a and slides the movable head portion 501c on the X-axis direction rail 501b so as to move them to the loader section 50.

Then, the loader section conveyor device 501 performs alignment above the recessed portions 503a on the heat plate 503, extends the Z-axis direction actuator of the movable head portion 301c, and releases the suction pads 501e to drop IC devices 2 into the recessed portions 503a on the heat plate 503. When the IC devices 2 are heated to a predetermined temperature by the heat plate 503, the loader section conveyor device 501 holds the heated four IC devices 2 again and moves to above one of the standby loader buffer portions 502.

The loader section conveyor device 501 performs alignment above the buffer stage 502a of the other standby loader buffer portions 502, extends the Z-axis direction actuator of the movable head portion 501c, and releases IC devices 2 picked up and held by the suction pads 501e of the suction portion 501d so as to place them in the recessed portions 502c on the buffer stage 502a. The suction means provided to the recessed portions 502c holds by suction the IC devices 2 placed in the recessed portions 502c.

The loader buffer portion 502 extends the X-axis direction actuator 502b while holding by suction four IC devices 2 in the recessed portions 502c on the buffer stage 502a and moves the four IC devices 2 from an operation range of the loader section conveyor device 501 of the loader section 50 to an operation range of the test section conveyor device 310 of the test section 30.

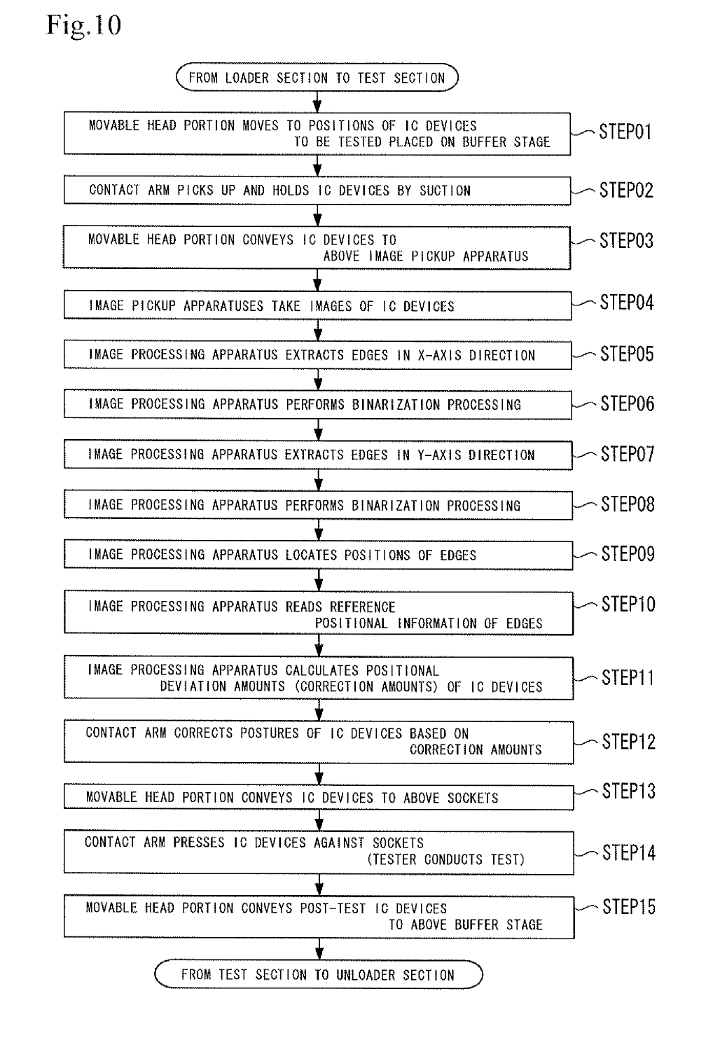

Subsequent operations in the test section 30 will be explained with reference to the flowchart in FIG. 10.

When the buffer stage 502a loaded with IC devices 2 moves into the operation range of the test section conveyor device 310 as explained above, the movable head portion 312 of the test section conveyor device 310 moves to above the IC devices 2 placed in the recessed portions 502c on the buffer stage 502a (Step 01). Then, the first Z-axis direction actuator 313a of the movable head portion 312 extends, and the suction portions 317 of the four contact arms 315 of the movable head portion 312 pick up and hold four IC devices 2 placed in the recessed portions 502c on the buffer stage 502a of the loader buffer portion 502 (Step 02). Note that it is preferable that suction at the recessed portions 502c on the buffer stage 502a is released at this time.

The movable head portion 312 holding the four IC devices 2 elevates by the first Z-axis direction actuator 313a of the movable head portion 312.

Next, the test section conveyor device 310 slides the X-axis direction supporting member 311a, which supports the movable head portion 312, on the Y-axis direction rail 311 so as to convey the four IC devices 2 held by the contact arms 315 of the movable head portion 312 to above the image pickup apparatuses 320 (Step 03: refer to FIG. 3).

The image pickup apparatuses 320 take images of a side (bottom surface) having pads 2a of the IC devices 2 (Step 04). At this time, the lighting device 321 lights the four IC devices 2 brightly.

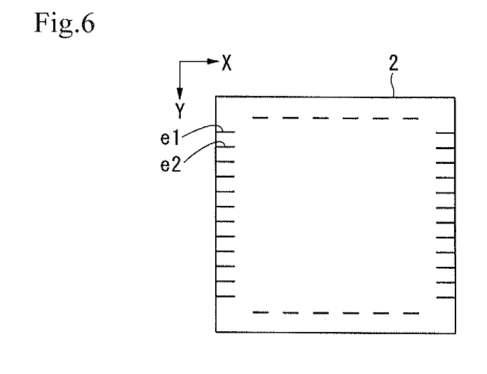

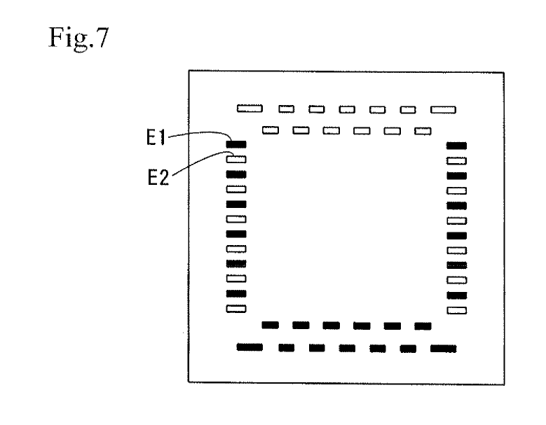

The image processing apparatus extracts edges (boundaries of light and dark) extending in the X-axis direction from data of an image of each IC device 2 taken by each of the image pickup apparatuses 320 first (Step 05). Specifically, scanning in the Y-axis direction is performed to extract edges where dark changes to light and edges where light changes to dark. Edges extending in the X-axis direction on the IC device 2 are shown in FIG. 6. In FIG. 6, e1 indicates edges where dark changes to light and e2 indicates edges where light changes to dark. Also, an image of extracted edges is shown in FIG. 7. In FIG. 7, E1 indicates the edges e1 where dark changes to light, indicated in black. Also, E2 indicates the edges e2 where light changes to dark, indicated in white. Background (parts other than the E1 and E2) of the image is gray color.

Next, the image processing apparatus performs binarization processing on data of extracted edges above (Step 06). Specifically, binarization for taking out the black portions (E1) and binarization for taking out the white portions (E2) from the image of extracted edges shown in FIG. 7 are performed. At this time, the binarization of taking out the black portions and that of taking out the white portions may be performed separately to obtain two binary images, or these binarization may be performed at a time to obtain one binary image. Note that, in the latter case, adjacent edge portions contact with each other and the edge positions cannot be located in some cases where pitches of pads 2a of the IC device 2 are fine, while the former has an advantage of being able to handle finer pitches, as well. Through the steps 05 and 06, positions of edges of the pads 2a arranged in the Y-axis direction on the IC devices 2 can be obtained.

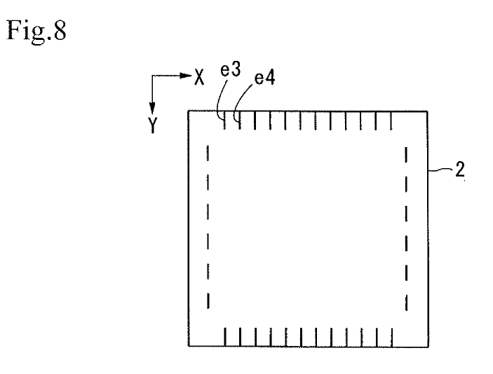

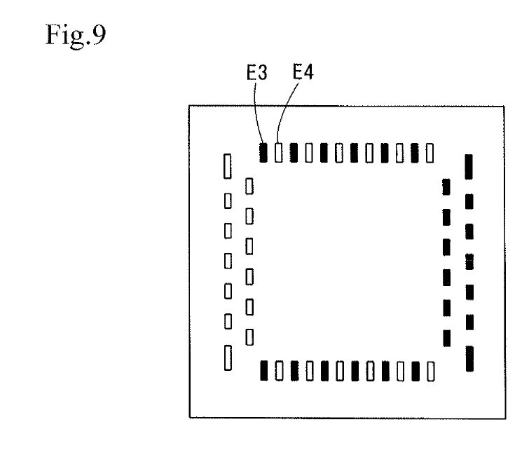

In the same way, the image processing apparatus extracts edges extending in the Y-axis direction from data of the image of the IC device 2 taken by the image pickup apparatus 320 (Step 07). Specifically, scanning in the X-axis direction is performed to extract edges where dark changes to light and edges where light changes to dark. Edges extending in the Y-axis direction on the IC device 2 are shown in FIG. 8. In FIG. 8, e3 are edges where dark changes to light and e4 are edges where light changes to dark. Also, an image of extracted edges is shown in FIG. 9. In FIG. 9, E3 indicates the edges e3 where dark changes to light, indicated in black. Also, in FIG. 9, E4 indicates the edges e4 where light changes to dark, indicated in white. Background (parts other than E3 and E4) of the image is gray color.

Next, the image processing apparatus performs binarization processing on data of the extracted edges above (Step 08). Specifically, binarization of taking out the black portions (E3) and binarization of taking out the white portions (54) from the image of extracted edges shown in FIG. 9 are performed. At this time, the binarization of taking out the black portions and that of taking out the white portions may be performed separately to obtain two binary images or they may be performed at a time to obtain one binary image. However, the former is preferable in terms of accuracy. Through the steps 07 and 08, positions of edges of the pads 2a arranged in the X-axis direction on the IC devices 2 can be obtained.

The image processing apparatus locates positions of the edges of respective pads 2a on the IC device 2 from the binary images obtained in the step 06 and the binary images obtained in the step 08 (Step 09). Specifically, positions of the edges of the respective pads 2a on the IC device 2 are located from data obtained by adding what obtained by ignoring unnecessary parts (parts corresponding to the upper white part and the lower black part in FIG. 7) in the two binary images obtained in the step 06 and what obtained by ignoring unnecessary parts (parts corresponding to the white part on the left and the black part on the right in FIG. 9) of the two binary images obtained in the step 08.

According to the position detection method as explained above, even if the background of the IC device 2 shines at the time of taking an image by the image pickup apparatus 320 and an image wherein the respective pads 2a are connected with the bright part of the background is obtained, the edges of the respective pads 2a on the IC device 2 can be detected and, consequently, a position of the IC device 2 can be located.

Next, the image processing apparatus reads model data (reference positional information of edges of respective pads of a reference IC device) from the memory device (Step 10). Then, the read-out reference positional information of edges of respective pads is compared with positional information of the edges of respective pads located in the step 09, a positional deviation amount of the IC device 2 held by the contact arm 315 is calculated and, based thereon, a correction amount (δx, δy and δθ) of a posture of the IC device 2 is calculated (Step 11).

The contact arm 315 of the movable head portion 312 moves the movable portion 315b based on the above calculated correction amount (δx, δy and δθ) of the posture of the IC device 2 and corrects the posture of the IC device 2 (Step 12).

Next, the test section conveyor device 310 slides on the Y-axis direction rail 311 the X-axis direction supporting member 311a supporting the movable head portion 312, and conveys the four IC devices 2 held by the suction portions 317 of the contact arm 315 of the movable head portion 312 to above the four sockets 301a on the contact portion 301 of the test head 300 (Step 13).

The movable head portion 312 extends the first Z-axis direction actuator 313a and the second Z-axis direction actuators 313b holding the IC devices 2 (refer to FIG. 4) to bring the pads 2a of the respective IC devices 2 contact with the contact pins 301b of the sockets 301a (Step 14). During this contact, electric signals are transmitted and received via the contact pins 301b to conduct a test on the IC devices 2.

When the test on the IC devices 2 is completed, the test section conveyor device 310 elevates the post-test IC devices 2 by retracting the first Z-axis direction actuator 313a and second Z-axis direction actuators 313b of the movable head portion 312. Then the X-axis direction supporting member 311a supporting the movable head portion 312 is made slide on the Y-axis direction rail 311, so that the four IC devices 2 held by the contact arms 315 of the movable head portion 312 are conveyed to above the buffer stage 602a of one of the unloader buffer portions 602 being standby in the operation range of the test section conveyor device 310 (STEP 15).

The movable head portion 312 extends the first Z-axis direction actuator 313a and releases the suction pads 317c to drop the four IC devices to the recessed portions 602c on the buffer stage 602a.

The unloader buffer portion 602 drives the X-axis actuator 602b while carrying the post-test four IC devices and moves the IC devices from the operation range of the test section conveyor device 310 of the test section 30 to the operation range of the unloader section conveyor device 601 of the unloader section 60.

Next, the Z-axis direction actuator of the movable head portion 601c of the unloader section conveyor device 601 positioned above the unloader buffer portion 602 is extended, and the four suction portions 601d of the movable head portion 601c pick up and hold post-test four IC devices placed in the recessed portions 602c of the buffer stage 602a of the unloader buffer portion 602.

The unloader section conveyor device 601 elevates the four IC devices by the Z-axis direction actuator of the movable head potion 601c while carrying the post-test four IC devices, slides the X-axis direction rail 601b on the Y-axis direction rail 601a and slides the movable head portion 601c on the X-axis direction rail 601b so as to move them to above the classification tray stockers 402 at the IC device magazine 40. Then, in accordance with the test results of the IC devices, the respective IC devices are loaded on classification trays at the uppermost level of the classification tray stockers 402.

In the handler 10 operating as above, positions of IC devices 2 held by the contact arm 315 can be accurately located and posture correction of the IC devices 2 with respect to the sockets 301a can be performed accurately. Particularly, a conventional handler had only one positional information (center coordinates) on one pad 2a of an IC device 2, on the other hand, the handler 10 according to the present embodiment has positional information on two edges on one pad 2a, so that a position of the IC device 2 can be located furthermore accurately.

The embodiments explained above are described to facilitate understanding of the present invention and is not to limit the present invention. Accordingly, respective elements disclosed in the above embodiments include all design modifications and equivalents belonging to the technical scope of the present invention.

For example, in the above position detection method, alternately, positions of edges of a part of the pads 2a, for example, pads 2a at the four corners of the IC devices 2 may be located instead of locating positions of edges of all pads 2a on the IC devices 2.

Also, in the above embodiment, the located positions of the edges of the pads 2a on the IC device 2 were used for position correction of the IC devices 2, however, it is not limited to that and they may be used for detecting defective pads 2a.

For example, by comparing the reference positional information of edges of respective pads read in the step 10 with the positional information of edges of respective pads located in the step 09 and, when the difference is larger than a predetermined level, it is possible to detect that the pads 2a are defective (for example, pads 2a are formed to be deviated, size of the pads 2a was wrong or pads 2a are dirty, etc.). It is possible to treat such IC devices 2 not to be tested in advance.

Furthermore, in the present embodiment, positions of the edges were located from the extracted edges, however, it is not limited to this and pitches of the edges may be detected directly from the extracted edges. A size of (terminals of) the IC devices 2 can be checked by using this.

For example, reference pitch information of edges of pads 2a of a reference IC device 2 is stored in advance. Edges of pads 2a of an IC device 2 are extracted from data of an image taken by an image pickup apparatus 320 as explained above to detect pitches of the edges. Then, by reading the stored reference pitch information of the edge and comparing it with information of detected edge pitches, a size of the IC device 2 can be checked. Namely, when a difference between the reference pitch information and the detected edge pitch information is larger than a predetermined level, it is possible to detect that the pads 2a of the IC device 2 are wrong (for example, the size of the pads 2a is wrong or the pads 2a are dirty, etc.). Also, because the outer size of the IC device 2 normally corresponds to edge pitches of pads 2a on the IC device 2 by one to one, when a difference between the reference pitch information and information of the detected edge pitches is larger than a predetermined level, it is possible to detect that the outer size of the IC device 2 is wrong or a kind of the IC device 2 to be tested is wrong.

### INDUSTRIAL APPLICABILITY

The present invention is useful for efficiently conducting a test by bringing an electronic device having terminals at its end edge portions, such as a QFN, contact with a contact portion accurately in an electronic device handling apparatus.

1. An electronic device handling apparatus for conducting a test of electric characteristics of an electronic device having terminals at its end edge portions by conveying said electronic device to a contact portion and bringing it electrically contact with the contact portion, comprising:
an image pickup apparatus for taking an image of terminals of a predetermined electronic device; and
an edge detection means for extracting edges of terminals of said electronic device from data of an image taken by said image pickup apparatus and locating positions of said edges.

2. The electronic device handling apparatus as set forth in claim 1, wherein said edge detection means extracts edges of terminals being in the direction crossing with an arrangement direction of terminals of said electronic device.

3. The electronic device handling apparatus as set forth in claim 1, wherein
said electronic device has terminals at its end edge portions in the X-axis direction and end edge portions in the Y-axis direction, and
said edge detection means extracts edges of terminals arranged in the X-axis direction of said electronic device and extracts edges of terminals arranged in the Y-axis direction of said electronic device.

4. The electronic device handling apparatus as set forth in claim 1, wherein said edge detection means performs scanning in a predetermined direction on terminals of said electronic device and extracts edges where light changes to dark and edges where dark changes to light.

5. The electronic device handling apparatus as set forth in claim 4, wherein said edge detection means locates positions of edges of said terminals after performing binarization processing on said extracted edges.

6. The electronic device handling apparatus as set forth in claim 5, wherein binarization is performed by taking out edges where light changes to dark and edges where dark changes to light at a time in said binarization processing.

7. The electronic device handling apparatus as set forth in claim 5, wherein binarization is performed by taking out edges where light changes to dark and edges where dark changes to light separately in said binarization processing.

8. The electronic device handling apparatus as set forth in claim 4, wherein
said electronic device has terminals on its end edge portions in the X-axis direction or its end edge portions in the Y-axis direction, and
said scanning is performed along an arrangement direction of terminals of said electronic device.

9. The electronic device handling apparatus as set forth in claim 4, wherein
said electronic device has terminals on its end edge portions in the X-axis direction and end edge portions in the Y-axis direction, and
said scanning is performed in the X-axis direction and the Y-axis direction.

10. The electronic device handling apparatus as set forth in claim 1, comprising a conveyor device capable of holding an IC device and pressing it against said contact portion:
wherein said image pickup apparatus takes an image of terminals of a pre-test electronic device held by said conveyor device.

11. The electronic device handling apparatus as set forth in claim 1, furthermore comprising:
a memory device for storing reference positional information of edges of terminals of a reference electronic device; and
a positional deviation detection means for reading said reference positional information of said edges from said memory device, comparing the read-out reference positional information of edges with information of positions of said edges located by said edge detection means and calculating a positional deviation amount of said predetermined electronic device.

12. The electronic device handling apparatus as set forth in claim 11, comprising a conveyor device capable of holding an IC device and pressing it against said contact portion:
wherein
said conveyor device comprises a posture correction device for correcting a posture of an electronic device held by the conveyor device;
said image pickup apparatus takes an image of terminals of pre-test electronic device held by said conveyor device; and
said conveyor device corrects a posture of an electronic device held by the conveyor device based on a positional deviation amount of said electronic device detected by said positional deviation detection means.

13. The electronic device handling apparatus as set forth in claim 1, furthermore comprising:
a memory device for storing reference positional information of edges of terminals of a reference electronic devices; and
a defective terminal detection means for detecting a defective terminal of said predetermined electronic device by reading said reference positional information of edges from said memory device and comparing the read-out reference positional information of edges with information of positions of said edges located by said edge detection means.

14. An electronic device handling apparatus for conducting a test of electric characteristics of an electronic device having terminals at its end edge portions by conveying said electronic device to a contact portion and bringing it electrically contact with the contact portion, comprising:
an image pickup apparatus for taking an image of terminals of a predetermined electronic devices;
an edge pitch detection means for detecting edge pitches of said terminals by extracting edges of terminals of said electronic device from data of image taken by said image pickup apparatus;
a memory device for storing reference pitch information of edges of terminals of a reference electronic device; and
a size checking means for checking a size of said predetermined electronic device by reading reference pitch information of edges of terminals of a reference electronic device and comparing the read-out reference pitch information of edges with information of said edge pitches detected by said edge pitch detection means.

15. A position detection method for detecting a position of an electronic device having terminals at its end edge portion in an electronic device handling apparatus, comprising:
a first step of taking an image of terminals of an electronic device; and
a second step of extracting edges of terminals of said electronic device from data of an image taken in said first step and locating a position of said edges.

16. The position detection method as set forth in claim 15, wherein said second step includes extracting of edges of terminals being in the direction crossing with an arrangement direction of terminals of said electronic device.

17. The position detection method as set forth in claim 15, wherein
said electronic device has terminals at its end edge portions in the X-axis direction and end edge portions in the Y-axis direction, and
said second step comprises a step of extracting edges of terminals arranged in the X-axis direction of said electronic device and a step of extracting edges of terminals arranged in the Y-axis direction of said electronic device.

18. The position detection method as set forth in claim 15, wherein said second step includes performing of scanning in a predetermined direction on terminals of said electronic device and extracting of edges where light changes to dark and edges where dark changes to light.

19. The position detection method as set forth in claim 18, wherein positions of edges of said terminals are located after performing binarization processing on said extracted edges in said second step.

20. The position detection method as set forth in claim 19, wherein binarization is performed by taking out edges where light changes to dark and edges where dark changes to light at a time in said binarization processing.

21. The position detection method as set forth in claim 19, wherein binarization is performed by taking out edges where light changes to dark and edges where dark changes to light separately in said binarization processing.

22. The position detection method as set forth in claim 18, wherein
said electronic device has terminals at its end edge portions in the X-axis direction or its end edge portions in the Y-axis direction, and
said scanning is performed along an arrangement direction of terminals of said electronic device.

23. The position detection method as set forth in claim 18, wherein
said electronic device has terminals at its end edge portions in the X-axis direction and end edge portions in the Y-axis direction, and
said scanning is performed in the X-axis direction and the Y-axis direction.

24. A positional deviation detection method for detecting positional deviation of an electronic device having terminals at its end edge portions in an electronic device handling apparatus, comprising:
a first step of storing reference positional information of edges of terminals of a reference electronic device;
a second step of taking an image of terminals of a predetermined electronic device;
a third step of extracting edges of terminals of said electronic device from data of an image taken in said second step and locating positions of said edges; and
a fourth step of reading reference positional information of said edges from said memory device, comparing the read-out reference positional information of edges with information of positions of said edges located in said third step and calculating a positional deviation amount of said predetermined electronic device.

25. A posture correction method for correcting a posture of an electronic device having terminals at its end edge portions held by a conveyor device in an electronic device handling apparatus, comprising:
a first step of storing reference positional information of edges of terminals of a reference electronic device;
a second step of taking an image of terminals of an electronic device held by said conveyor device;
a third step of extracting edges of terminals of said electronic device from data of an image taken in said second step and locating positions of said edges;
a fourth step of reading reference positional information of said edges from said memory device, comparing the read-out reference positional information of edges with information of positions of said edges located in said third step and calculating a positional deviation amount of an electronic device held by said conveyor device; and
a fifth step of correcting a posture of an electronic device held by said conveyor device based on a positional deviation amount of said electronic device detected in said fourth step.

26. A defective terminal detection method for detecting a defective terminal of an electronic device having terminals at its end edge portions in an electronic device handling apparatus, comprising:
a first step of storing reference positional information of edges of terminals of a reference electronic device;
a second step of taking an image of terminals of a predetermined electronic device;
a third step of extracting edges of terminals of said electronic device from data of an image taken in said second step and locating positions of said edges; and
a fourth step of reading reference positional information of said edges from said memory device and comparing the read-out reference positional information of edges with information of positions of said edges located in said third step so as to detect a defective terminal of said predetermined electronic device.

27. A size checking method for checking a size of an electronic device having terminals at its end edge portions in an electronic device handling apparatus, comprising:
a first step of storing reference pitch information of edges of terminals of a reference electronic device;
a second step of taking an image of terminals of a predetermined electronic device;
a third step of extracting edges of terminals of said electronic device from data of an image taken in said second step and detecting edge pitches of said terminals; and
a fourth step of reading reference pitch information of said edges from said memory device and comparing the read-out reference pitch information of edges with information of said edge pitches detected in said third step so as to check a size of said predetermined electronic device.
